SEQUENCE LISTING (1 sequence)

SEQ ID NO: 1 - protein, 482 aa, Artificial Sequence
  Hybridprotein
HDGTNGTIMQYFEWNVPNDGQHWNRLHNNAQNLKNAGITAIWIPPAWKGTSQSDTGYGAYDLYDLGEFNQRGTVRTKYGTKAELERAIRSLKANGIQVYGDVVMNHKAGADQTEQVQAVEVNPQNRNQEVSGTYQIEAWTGFNFPGRGNQHSSFKWRWYHFDGTDFDQSRGLSNRIYKFRTKAWDWEVDTEFGNYDYLMYADLDMDHPEVINELNRWGVWYANTLNLDGFRLDAVKHIKFSFMRDWLGHVRGQTGKNLFAVAEYWKNDLGALENYLSKTNWTMSAFDVPLHYNLYQASNSSGNYDMRNLLNGTLVQRHPSHAVTFVDNHDTQPGEALESFVQGWFKPLAYATILTREQGYPQVFYGDYYGIPSDGVPSYRQQIDPLLAARQQYAYGTQHDYLDNQDVIGWTREGDSAHAGSGLATVMSDGPGGSKTMYVGTAHAGQVFKDITGNRTDTVTINSAGNGTFRCNKGSVSIWVKQ

(19) United States
(12) Patent Application Publication
(10) Pub. No.: US 2019/0330570 A1
(43) Pub. Date: Oct. 31, 2019

(54) AMLYASE FOR DETERGENT AND CLEANING AGENT APPLICATIONS

(71) Applicant: Henkel AG & Co. KGaA, Duesseldorf (DE)

(72) Inventors: DANIELA HERBST, Duesseldorf (DE); SUSANNE WIELAND, Zons/Dormagen (DE); TIMOTHY O'CONNELL, Landsberg am Lech (DE); NINA MUSSMANN, Willich (DE); BRIAN LAUFS, Juechen (DE); MARIANNE SCHMELING, Korschenbroich (DE); DETLEF BUISKER, Essen (DE); THOMAS WEBER, Weimar (Lahn) (DE)

(73) Assignee: Henkel AG & Co. KGaA, Duesseldorf (DE)

(21) Appl. No.: 16/347,965

(22) PCT Filed: Oct. 20, 2017
(86) PCT No.: PCT/EP2017/076858

§ 371 Date: May 7, 2019

(30) Foreign Application Priority Data
Nov. 8, 2016 (DE) 10 2016 221 851.4

(51) Int. Cl. C11D 3/386

(52) U.S. Cl. CPC C11D 3/38618; C12Y 302/01001

(57) ABSTRACT

The present disclosure relates to a washing or cleaning agent, in particular a liquid washing or liquid cleaning agent containing an amylase, wherein the amino acid sequence of the amylase has been changed in particular with regard to the use in washing and cleaning agents. The present disclosure further relates to methods for the cleaning of textiles and hard surfaces and uses of these washing or cleaning agents.

### CROSS-REFERENCE TO RELATED APPLICATION

This application is a U.S. National-Stage entry under 35 U.S.C. § 371 based on International Application No. PCT/EP2017/076858, filed Oct. 20, 2017, which was published under PCT Article 21(2) and which claims priority to German Application No. 10 2016 221 851.4, filed Nov. 8, 2016, which are all hereby incorporated in their entirety by reference.

### TECHNICAL FIELD

The present disclosure is in the field of enzyme technology. The present disclosure relates to agents, preferably washing or cleaning agents, more preferably liquid washing or cleaning agents containing an amylase which has improved storage stability. The present disclosure further relates to methods for the cleaning of textiles and hard surfaces and uses of these washing or cleaning agents.

### BACKGROUND

Amylases are among the most technically important enzymes. Their use for washing and cleaning agents is established industrially and they can be contained in modern, powerful washing and cleaning agents. Amylases are subdivided into α-, β-, γ- and isoamylases. Amylases are classified as a hydrolase (an enzyme that hydrolytically cleaves) or as a glycosidase (an enzyme that cleaves polysaccharides). α-amylases (EC 3.2.1.1) cleave internal α(1-4) glycoside bonds of amylose, but not terminal or α(1-6) glycoside bonds. This produces maltose, maltotriose and branched oligosaccharides. β-amylases (EC 3.2.1.2) split off a maltose molecule from the chain end in saccharides. γ-amylases (EC 3.2.1.3) in saccharides split off a β-D-glucose molecule from the chain end. Isoamylases (EC 3.2.1.68) occur only in plants and bacteria and cleave the 1,6-glycosidic branches of glycogen and amylopectin. The amylases used in the washing or cleaning agents known from the prior art are usually of microbial origin and are generally derived from bacteria or fungi, for example, the genera Bacillus, Pseudomonas, Acinetobacter, Micrococcus, Humicola, Trichoderma or Trichosporon, in particular Bacillus. Amylases are usually produced according to biotechnological methods known per se by suitable microorganisms, for example, by transgenic expression hosts of the genera Bacillus or by filamentous fungi.

A particularly extensively exemplified alpha-amylase is one from the alkalophilic Bacillus sp. Strain TS-23, which hydrolyzes at least five types of starch (Lin et al., Biotechnol Appl Biochem, 28: 61-68, 1998). The alpha-amylase from Bacillus sp. Strain TS-23 has a pH optimum of about 9, although it is stable over a broad pH range (that is, pH from about 4.7 to about 10.8). Its optimum temperature is about 45° C., wherein the enzyme also has activity at lower temperatures, for example, from about 15-20° C.

Also, the U.S. Pat. Nos. 7,407,677 B2 and 8,852,912 B2 disclose specific alpha-amylases and their fragments for use in washing and cleaning agents.

In general, only selected amylases are suitable for use in surfactant-containing preparations. Many amylases do not show sufficient catalytic performance or stability in such formulations. In particular, when used in washing agents, which are normally purchased in an amount by the consumer so that several weeks or months can elapse (that is, the washing agents must be stored by the consumer for weeks or months) until final consumption of the washing agent, many amylases show instability which, in turn, leads to insufficient catalytic activity during the washing process.

Consequently, prior art amylase-containing formulations have the disadvantage that they often do not have satisfactory hydrolytic activity after storage of the formulation and therefore do not show optimal cleaning performance on amylase-sensitive soilings.

### BRIEF SUMMARY

This disclosure provides an agent such as a washing or cleaning agent or a liquid washing or liquid cleaning agent, that includes at least one amylase including an amino acid sequence having at least about 75% sequence identity over its entire length with the amino acid sequence given in SEQ ID NO:1.

This disclosure also provides a washing or cleaning method comprising the method steps of a) providing a washing or cleaning solution comprising the aforementioned agent and b) bringing a textile or a hard surface into contact with the washing or cleaning solution according to step (a).

Surprisingly, it has now been found that an amylase according to SEQ ID NO:1 or a sufficiently similar amylase with respect to the (storage) stability is improved over a reference amylase and therefore particularly suitable for use in washing or cleaning agents.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Therefore, in a first aspect, the present disclosure is directed to an agent, preferably washing or cleaning agents, more preferably liquid or liquid washing agents, exemplified in that it contains at least one amylase comprising an amino acid sequence having at least about 75% sequence identity over its entire length with the amino acid sequence given in SEQ ID NO:1.

In a further aspect, the present disclosure is directed to the use of the agent as contemplated herein for the removal of starch-containing soilings.

In yet another aspect, the present disclosure is further directed to a washing method comprising the method steps of a) providing a washing or cleaning solution comprising an agent as contemplated herein, and b) bringing a textile or a hard surface into contact with the washing or cleaning solution according to (a).

In the context of the present disclosure, when defining a number range where a number is to lie “between” two range limits, the range limits are not included, following general language usage. Number ranges defined from one range limit to another range limit include the range limits.

“At least one” as used herein includes, but is not limited to, about 1, 2, 3, 4, 5, 6 and more.

All percent specifications made in connection with the compositions described herein are, unless explicitly stated otherwise, refer to % by weight, in each case based on the mixture/composition in question.

In the context of the present disclosure fatty acids or fatty alcohols or their derivatives, unless otherwise stated, stand for branched or unbranched carboxylic acids or alcohols or their derivatives having preferably about 6 to about 22 carbon atoms. In particular, the oxo alcohols or their derivatives, which are obtainable, for example, by the Roelen oxo synthesis, can also be used correspondingly. Whenever alkaline earth metals are referred to below as counterions for monovalent anions, this means that the alkaline earth metal is naturally present only in half the amount of substance as the anion, as sufficient to balance the charge.

The agents described herein are washing or cleaning agents, more preferably liquid washing or liquid cleaning agents. As contemplated herein, a cleaning agent is to be understood as meaning all agents which are suitable for cleaning solid surfaces, for example, dishwashing agents, in particular hand dishwashing washing agents. As contemplated herein, a washing agent is understood as meaning all agents that are suitable for cleaning or treating textiles, including special washing agents and auxiliary washing agents. Further suitable ingredients of such agents are described in detail below.

“Liquid” as used herein with respect to the agents described includes all compositions that are flowable at room temperature and also includes, for example, gels.

The present disclosure is based on the surprising finding that an amylase according to SEQ ID NO:1 or a sufficiently similar amylase exhibits an improved (storage) stability. This is particularly surprising inasmuch as the abovementioned amylase has not previously been associated with increased stability in surfactant compositions.

The amylases relevant to the present disclosure have increased stability in washing or cleaning agents, in particular when stored for about 2 or more days, about 4 or more days, about 10 or more days, about 2 or more weeks, about 4 or more weeks or about 8 or more weeks. Such agents having performance enhancing amylase enable improved wash results on starch-sensitive soilings over a wide temperature range.

The amylases relevant to the present disclosure have enzymatic activity, that is, they are capable of the hydrolysis of starch, in particular in a washing or cleaning agent. An amylase relevant to the present disclosure is therefore an enzyme which catalyzes the hydrolysis of glycosidic bonds in starch substrates and is thereby able to cleave starch. Furthermore, an amylase relevant to the present disclosure is preferably a mature amylase, that is, the catalytically active molecule without signal and/or propeptide(s). Unless otherwise stated, the sequences given refer to respectively mature (processed) enzymes.

In various embodiments, the agent, preferably washing or cleaning agent, particularly preferably liquid washing or liquid cleaning agent, is exemplified in that (a) the amylase is obtainable from an amylase as contemplated herein as a starting molecule by single or multiple conservative amino acid substitution; and/or (b) the amylase is obtainable from an amylase as contemplated herein as a starting molecule by fragmentation, deletion, insertion or substitution mutagenesis and comprises an amino acid sequence which matches the starting molecule over the length of at least about 370, 380, 390, 400, 410, 420, 430, 440, 450, 460, 470, 480 or 482 contiguous amino acids.

In further embodiments, the agent as contemplated herein is exemplified in that the agent contains the amylase from about 0.0001 to about 1% by weight, preferably from about 0.006 to about 0.6% by weight of the amylase, based on the total weight.

In a further embodiment as contemplated herein, the amylase comprises an amino acid sequence which is identical to the amino acid sequence given in SEQ ID NO:1 over its total length to at least about 76%, about 77%, about 78%, about 79%, about 80%, about 81%, about 82%, about 83%, about 84%, about 85%, about 86%, about 87%, about 88%, about 89%, about 90%, about 90.5%, about 91%, about 91.5%, about 92%, about 92.5%, about 93%, about 93.5%, about 94%, about 94.5%, about 95%, about 95.5%, about 96%, about 96.5%, about 97%, about 97.5%, about 98%, about 98.5%, about 98.8%, about 99%, about 99.5% or about 100%.

In further embodiments as contemplated herein, the agent as contemplated herein does not contain the following composition: a) a total amount of from about 2.0 to about 8.0% by weight of C₉-C₂₀ alkylbenzenesulfonate, and b) a total amount of from about 10.0 to about 18.0% by weight R¹—O—(CH₂CH₂O)ₙ—SO₃M, wherein R¹ stands for a C₁₂₋₁₈ alkyl group, n stands for a number from about 2 to about 3 and M stands for a monovalent cation, and c) a total of from about 1.0 to about 6.0% by weight percent R²—O—(CH₂CH₂O)ₘ—SO₃M′ wherein R² stands for a C₁₂₋₁₈ alkyl group, M stands for a number from about 7 to about 8 and M′ stands for a monovalent cation, and d) a total amount of from about 2.0 to about 10.0% by weight, preferably from about 2.5 to about 7.5% by weight, more preferably from about 4.0 to about 6.0% by weight of fatty alcohol ethoxylate(s), and e) water and 0 at least one amylase, wherein the amylase comprises an amino acid sequence which has at least about 70% sequence identity with the amino acid sequence given in SEQ ID NO:1 over its entire length, wherein the % by weight specification refers to the total weight of the composition.

The composition as contemplated herein necessarily contains at least one amylase. This amylase is a α-Amylase and comprises an amino acid sequence having at least about 75% sequence identity with the amino acid sequence given in SEQ ID NO:1 over the entire length thereof α-amylases (EC 3.2.1.1) hydrolyze as an enzyme internal α-1,4-glycosidic bonds of starch and starch-like polymers.

The amount of such amylase is typically from about 0.01 to about 1% by weight based on active protein.

Preferred embodiments of said agents with said amylase achieve the advantageous cleaning performances at low temperatures between about 10° C. and about 60° C., between about 15° C. and about 50° C. and between about 20° C. and about 40° C. Consequently, particularly preferred embodiments of said agents are provided with said amylase, the cleaning performance of which is advantageous with regard to a soiling or to several soilings of similar type, in particular at temperatures of at most about 25° C., particularly preferably at temperatures of at most about 20° C.

Furthermore, preferred embodiments of the amylase used in the agent as contemplated herein have a particular stability in washing or cleaning agents, for example, with respect to surfactants and/or bleaches and/or with respect to temperature influences, in particular with respect to high temperatures, for example, between about 50 and about 65° C., in particular about 60° C., and/or with respect to acidic or alkaline conditions and/or with respect to pH changes and/or with respect to denaturing or oxidizing agents and/or with respect to proteolytic degradation and/or with respect to a change in the redox ratios. Such advantageous embodiments of amylases as contemplated herein thus enable improved wash results of amylase-sensitive soilings in a wide temperature range.

In the context of the present disclosure, cleaning performance is understood as meaning the whitening performance on one or more soilings, in particular laundry or dishes. In the context of the present disclosure, both the washing or cleaning agent, which comprises the amylase or the washing or cleaning solution formed by this agent, and the amylase itself have a respective cleaning performance. The cleaning performance of the enzyme thus contributes to the cleaning performance of the agent or of the washing or cleaning solution formed by the agent. The cleaning performance is preferably determined as indicated below.

The identity of nucleic acid or amino acid sequences is determined by a sequence comparison. This sequence comparison is based on the BLAST algorithm established and commonly used in the prior art (see, for example, Altschul, S. F., Gish, W., Miller, W., Myers, E. W. & Lipman, D. J. (1990) “Basic local alignment search tool.” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pp. 3389-3402) and in principle occurs by assigning similar sequences of nucleotides or amino acids in the nucleic acid or amino acid sequences to one another. A tabular assignment of the respective positions is referred to as alignment. A further algorithm available in the prior art is the FASTA algorithm. Sequence comparisons (alignments), in particular multiple sequence comparisons, are created with computer programs. For example, the Clustal series are frequently used (see, for example, Chenna et al. (2003): Multiple sequence alignment with the Clustal series of programs. Nucleic Acid Research 31, 3497-3500), T-Coffee (see, for example, Notredame et al., (2000): T-Coffee: A novel method for multiple sequence alignments. J. Mol. Biol. 302, 205-217) or programs based on these programs or algorithms. In the present patent application, all sequence comparisons (alignments) were made with the Vector NTI® Suite 10.3 computer program (Invitrogen Corporation, 1600 Faraday Avenue, Carlsbad, Calif., USA) with the prespecified default parameters whose AlignX module for sequence comparison is based on ClustalW.

Such a comparison also allows a statement about the similarity of the sequences compared to each other. It is usually given in percent identity, that is, the proportion of identical nucleotides or amino acid residues at the same or in positions corresponding an alignment with each other. The broader concept of homology involves conserved amino acid substitutions in amino acid sequences, that is, amino acids having similar chemical activity, as these usually perform similar chemical activities within the protein. Therefore, the similarity of the sequences compared can also be stated as percent homology or percent similarity. Identity and/or homology specifications can be made about whole polypeptides or genes or only over individual regions. Homologous or identical regions of different nucleic acid or amino acid sequences are therefore defined by matches in the sequences. Such regions often have identical functions. They can be small and comprise only a few nucleotides or amino acids. Often, such small regions perform essential functions for the overall activity of the protein. It can therefore be useful to relate sequence matches only to individual, possibly small regions. Unless otherwise indicated, identity or homology specification in the present application, however, refers to the total length of the respectively specified nucleic acid or amino acid sequence.

In a very particularly preferred embodiment as contemplated herein, the amylase cleaning performance corresponds at least to that of an amylase comprising an amino acid sequence corresponding to the amino acid sequence specified in SEQ ID NO:1, wherein the cleaning performance is determined in a washing system which contains a washing agent in a dosage between about 4.5 and about 7.0 grams per liter of wash solution and the amylase, wherein the amylases to be compared in concentration (based on active protein) are used and the cleaning performance is determined by measuring the degree of whiteness of the washed textiles, the washing is performed for about 70 minutes at a temperature of about 40° C. and the water has a water hardness between about 15.5 and about 16.5° (German hardness). The concentration of the amylase in the washing agent determined for this washing system is from about 0.001 to about 0.1% by weight, preferably from about 0.01 to about 0.06% by weight, based on active protein.

In addition to the amino acid changes described above, amylases as contemplated herein can contain further amino acid changes, in particular amino acid substitutions, -insertions or -deletions. Such amylases are, for example, further developed by targeted genetic modification, that is, by mutagenesis methods, and optimized for specific applications or with regard to specific properties (for example, with regard to their catalytic activity, stability, etc.). Furthermore, nucleic acids as contemplated herein can be introduced into recombination approaches and thus used to generate completely novel amylases or other polypeptides.

The goal is to introduce into the known molecules targeted mutations such as substitutions, insertions or deletions, for example, to improve the cleaning performance of enzymes as contemplated herein. For this purpose, in particular, the surface charges and/or the isoelectric point of the molecules and thereby their interactions with the substrate can be changed. Thus, for example, the net charge of the enzymes can be changed in order to influence the substrate binding, in particular for use in washing and cleaning agents. Alternatively or additionally, one or more corresponding mutations can increase the stability of the amylase and thereby improve its cleaning performance. Advantageous properties of individual mutations, for example, individual substitutions, can be complementary. An amylase which has already been optimized with regard to certain properties, for example, with respect to its stability towards surfactants and/or bleaches and/or other components, can therefore be further developed within the scope as contemplated herein.

For the description of substitutions that concern exactly one amino acid position (amino acid substitutions), the following convention is used: first, the naturally occurring amino acid is designated in the form of the international one-letter code, then followed by the associated sequence position and finally the inserted amino acid. Several exchanges within the same polypeptide chain are separated from each other by slashes. For insertions, additional amino acids are named after the sequence position. For deletions, the missing amino acid is replaced by a symbol, such as a star or a dash. For example, A95G describes the substitution of alanine at position 95 by glycine, A95AG the insertion of glycine after the amino acid alanine at position 95, and A95* the deletion of alanine at position 95. This nomenclature is known to those skilled in the art of enzyme technology.

A further object of the present disclosure is therefore a washing and cleaning agent containing an α-amylase, wherein the α-amylase is obtainable from an amylase as contemplated herein as a starting molecule by one or more conservative amino acid substitution. The term “conservative amino acid substitution” means the substitution of one amino acid residue for another amino acid residue, wherein this substitution does not lead to a change in polarity or charge at the position of the exchanged amino acid, for example, the replacement of a nonpolar amino acid residue for another nonpolar amino acid residue. Conservative amino acid substitutions within the scope as contemplated herein include, for example: G=A=S, I=V=L=M, D=E, N=Q, K=R, Y=F, S=T, G=A=I=V=L=M=Y=F=W=P=S=T.

Another subject of the present disclosure is therefore a washing and cleaning agent containing an α-amylase, wherein the α-amylase is obtainable from an amylase as contemplated herein as a starting molecule by fragmentation, deletion, insertion or substitution mutagenesis and comprises an amino acid sequence which matches the starting molecule over a length of at least about 370, 380, 390, 400, 410, 420, 430, 440, 450, 460, 470, 475, 476, 477, 478, 479, 480, 481 or 482 contiguous amino acids.

Thus, for example, it is possible to delete individual amino acids at the termini or in the loops of the enzyme without thereby losing or reducing the enzymatic activity. Furthermore, such fragmentation, deletion, insertion or substitution mutagenesis can also reduce, for example, the allergenicity of the enzymes concerned and thus improve their overall applicability. Advantageously, the enzymes retain their enzymatic activity even after mutagenesis, that is, their enzymatic activity corresponds at least to that of the starting enzyme. Substitutions can also show beneficial effects. Both single and multiple contiguous amino acids can be substituted for other amino acids.

An enzyme as contemplated herein can additionally be stabilized, in particular by one or more mutations, for example, substitutions, or by coupling to a polymer. That is because an increase in stability during storage and/or during use, for example, during the washing process, causes the enzymatic activity to last longer and thus improve the cleaning performance. In principle, all stabilization options described in the prior art and/or functional considerations come into consideration. Preference is given to those stabilizations which are achieved by mutations of the enzyme itself, since such stabilizations do not require any further working steps following the extraction of the enzyme. Sequences suitable for this purpose are known from the prior art.

Other options for stabilization are, for example:
changing the binding of metal ions, in particular the calcium binding sites, for example, by replacing one or more of the amino acid(s) participating in the calcium binding for one or more negatively charged amino acids and/or by introducing sequence changes in at least one of the consequences of both amino acids arginine/glycine;
protection against the influence of denaturing agents such as surfactants by mutations that cause an alteration of the amino acid sequence on or at the surface of the protein;
replacing amino acids near the N-terminus with those likely to contact non-covalent interactions with the rest of the molecule, thus contributing to the maintenance of the globular structure.

Preferred embodiments are those in which the enzyme is stabilized in several ways, since several stabilizing mutations act additively or synergistically.

A further subject as contemplated herein is an agent as described above, which is exemplified in that the amylase has at least one chemical modification. An enzyme having such a change is called a derivative, that is, the enzyme is derivatized.

In the context of the present application, derivatives are understood as meaning those proteins whose pure amino acid chain has been chemically modified. Such derivatizations can be done, for example, in vivo by the host cell expressing the protein. In this regard, couplings of low molecular weight compounds such as lipids or oligosaccharides are particularly noteworthy. However, derivatizations can also be carried out in vitro, for example, by the chemical transformation of a side chain of an amino acid or by covalent binding of another compound to the protein. For example, the coupling of amines to carboxyl groups of an enzyme to alter the isoelectric point is possible. Another such compound can also be a further protein that is bound to a protein as contemplated herein via bifunctional chemical compounds, for example. Similarly, derivatization is to be understood as meaning the covalent binding to a macromolecular carrier, or else a noncovalent inclusion in suitable macromolecular cage structures. Derivatizations can, for example, affect the substrate specificity or binding strength to the substrate or cause a temporary blockage of the enzymatic activity when the coupled substance is an inhibitor. This can be useful, for example, for the period of storage. Such modifications can further affect stability or enzymatic activity. They can also serve to reduce the allergenicity and/or immunogenicity of the protein and thus, for example, increase its skin tolerance. For example, couplings with macromolecular compounds, for example, polyethylene glycol, can improve the protein in terms of stability and/or skin tolerance.

Derivatives of a protein as contemplated herein can also be understood as meaning preparations of these proteins in the broadest sense. Depending on the extraction, processing or preparation, a protein can be associated with various other substances, for example, from the culture of the producing microorganisms. A protein can also have been deliberately added to other substances, for example, to increase its storage stability. Therefore, all preparations of a protein as contemplated herein are also as contemplated herein. This is also independent of whether or not it actually exhibits this enzymatic activity in a particular preparation. That is because it can be desired that it has no or only low activity during storage, and exhibits its enzymatic function only at the time of use. This can be controlled, for example, via appropriate accompanying substances.

In various embodiments, the agent as contemplated herein can further comprise at least one further constituent selected from the group of surfactants, further enzymes, enzyme stabilizers, complexing agents for heavy metals, building compounds, bleaches, builders, electrolytes, nonaqueous solvents, pH adjusters, odor absorbers, deodorizing substances, perfumes, perfume carriers, fluorescers, dyes, hydrotropes, foam inhibitors, silicone oils, anti-redeposition agents, graying inhibitors, inlet preventer, further anti-creasing agents, color transfer inhibitors, antimicrobial active substances, germicides, fungicides, antioxidants, preservatives, corrosion inhibitors, anti-static agents, buttering agents, binding auxiliaries, repellents and impregnating agents, swelling and slip resistant agents, plasticizing components and UV absorbers.

The agent as contemplated herein can also contain, in addition to the amylase, a compound from the class of anionic surfactants of the formula (I)

R—SO₃⁻Y⁺ (I).

In this formula (I), R stands for a linear or branched unsubstituted alkylaryl radical. Y stands for a monovalent cation or the n-th part of an n-valent cation, the alkali metal ions being preferred, and Na⁺ or K⁺ being preferred, wherein Na⁺ is extremely preferred. Further cations Y⁺ can be selected from NH₄⁺, ½Zn²⁺, ½Mg²⁺, ½Ca²⁺, ½Mn²⁺, and mixtures thereof.

“Alkylaryl” as used herein refers to organic radicals including an alkyl radical and an aromatic radical. Typical examples of such radicals include, but are not limited to, alkylbenzene radicals such as benzyl, butylbenzene radicals, nonylbenzene radicals, decylbenzene radicals, undecylbenzene radicals, dodecylbenzene radicals, tridecylbenzene radicals, and the like.

In various embodiments, such surfactants are selected from linear or branched alkylbenzenesulfonates of the formula A-1

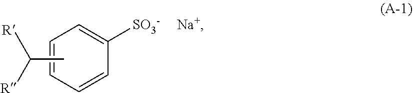

in which R′ and R″ together contain from about 9 to about 19, preferably from about 11 to about 15 and in particular from about 11 to about 13 C atoms. A particularly preferred representative can be described by the formula A-1a:

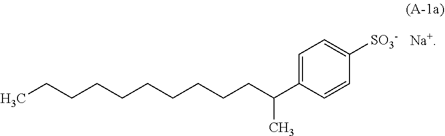

In various embodiments, the compound of formula (I) is preferably the sodium salt of a linear alkyl benzene sulfonate.

In agents as contemplated herein, the at least one compound from the class of anionic surfactants of the formula (I) can be contained in an amount of from about 0.001 to about 30% by weight, preferably from about 1-30% by weight, more preferably from about 2-25% by weight. still more preferably from about 3-20% by weight, in the washing or cleaning agent, each based on the total weight of the washing or cleaning agent.

In various embodiments, the agent can contain, in addition to the at least one compound of formula (I) or, alternatively, at least one other surfactant. In particular, further anionic surfactants, nonionic surfactants and mixtures thereof, but also cationic, zwitterionic and amphoteric surfactants are regarded as suitable alternative or additional surfactants.

In various embodiments, the agents as contemplated herein preferably contain at least one anionic surfactant from the group of alkyl ether sulfates.

Alkyl ether sulfates (fatty alcohol ether sulfates, INCI Alkyl Ether Sulfates) are products of sulfation reactions on alkoxylated alcohols. In this context, the person skilled in the art generally understands alkoxylated alcohols as meaning the reaction products of alkylene oxide, preferably ethylene oxide, with alcohols, in the context of the present disclosure preferably with longer-chain alcohols, that is, with aliphatic straight-chain or one or more branched, acyclic or cyclic, saturated or mono- or polyunsaturated, preferably straight-chain, acyclic, saturated, alcohols having from about 6 to about 22, preferably from about 8 to about 18, in particular from about 10 to about 16 and particularly preferably from about 12 to about 14 carbon atoms. In general, a complex mixture of addition products of different degrees of ethoxylation (n=from 1 to about 30, preferably from 1 to about 20, in particular from 1 to about 10, particularly preferably from 2 to 4) is produced from n moles of ethylene oxide and one mole of alcohol, depending on the reaction conditions. A further embodiment of the alkoxylation is the use of mixtures of the alkylene oxides, preferably the mixture of ethylene oxide and propylene oxide.

In various embodiments, the alkyl ether sulfate is in particular an anionic surfactant of the formula

R¹—O-(AO)ₙ—SO₃⁻X⁺ (II).

In this formula (II), R¹ stands for a linear or branched, substituted or unsubstituted alkyl radical, preferably a linear, unsubstituted alkyl radical, more preferably a fatty alcohol radical. Preferred radicals R¹ are selected from decyl, undecyl, dodecyl, tridecyl, tetradecyl, pentadecyl, hexadecyl, heptadecyl, octadecyl, nonadecyl, eicosyl radicals and mixtures thereof, wherein the representatives with an even number of carbon atoms are preferred. Particularly preferred radicals R¹ are derived from C₁₂-C₁₈ fatty alcohols, for example, coconut fatty alcohol, tallow fatty alcohol, lauryl, myristyl, cetyl or stearyl alcohol or C₁₀-C₂₀ oxo alcohols.

AO stands for an ethylene oxide (EO) or propylene oxide (PO) grouping, preferably an ethylene oxide grouping. The index n is an integer from about 1 to about 50, preferably from about 1 to about 20 and in particular from about 1 to about 10. Most preferably, n stands for the numbers of about 1, 2, 3, 4, 5, 6, 7 or 8. X stands for a monovalent cation or the n-th part of an n-valent cation, the alkali metal ions being preferred, and Na⁺ or K⁺ being preferred, wherein Na⁺ is extremely preferred. Further cations X+ can be selected from NH₄⁺, ½ Zn²⁺, ½ Mg²⁺, ½ Ca²⁺, ½ Mn²⁺, and mixtures thereof.

Particular preference is given to fatty alcohol ether sulfates of the formula A-2

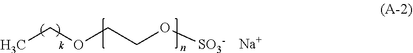

with k=11 to 19, n=1, 2, 3 or 4. Very particularly preferred representatives are Na—C₁₂₋₁₄ fatty alcohol ether sulfates having from about 1 to about 2 EO (k=11-13, n=1 or 2 in formula A-2), in particular about 2 EO.

The agent as contemplated herein, in particular a cleaning agent for hard surfaces, in particular a manual dishwashing washing agent, in one preferred embodiment contains one or more alkyl ether sulfates in an amount of from about 10 to about 40% by weight, preferably from about 13 to about 35% by weight, in particular from about 15 to about 30% by weight.

Furthermore, the alkyl sulfonates (INCI Sulfonic Acids) can be used as anionic surfactants. These usually have an aliphatic straight-chain or mono- or poly-branched, acyclic or cyclic, saturated or mono- or polyunsaturated, preferably branched, acyclic, saturated, alkyl radical having from about 6 to about 22, preferably from about 9 to about 20, in particular from about 11 to about 18 and particularly preferably from about 14 to about 17 carbon atoms.

Accordingly, suitable alkyl sulfonates are the saturated alkanesulfonates, the unsaturated olefin sulfonates and the ether sulfonates which are derived formally from the alkoxylated alcohols on which the alkyl ether sulfates are based, in which terminal ether sulfonates (n-ethersulfonates) having sulfonate function bound to the polyether chain and internal ether sulfonates (i-ethersulfonates) having sulfonate function associated with the alkyl radical are differentiated.

Preference as contemplated herein is given to the alkanesulfonates, in particular alkanesulfonates having a branched, preferably secondary, alkyl radical, for example, the secondary alkanesulfonate sec. Na—C₁₃₋₁₇-alkanesulfonate (INCI Sodium C14-17 Alkyl Sec Sulfonate).

The agent as contemplated herein, in particular a manual dishwashing agent, contains one or more secondary alkyl sulfonates in an amount of usually from about 1 to about 15% by weight, preferably from about 3 to about 10% by weight, in particular from about 4 to about 8% by weight.

Further possible anionic surfactants which can be used are known to the person skilled in the art from the relevant prior art for washing or cleaning agents. These include, in particular, aliphatic sulfates such as monoglyceride sulfates and ester sulfonates (sulfo fatty acid esters), lignosulfonates, fatty acid cyanamides, anionic sulfosuccinic acid surfactants, fatty acid isethionates, acylaminoalkanesulfonates (fatty acid taurides), fatty acid sarcosinates, ether carboxylic acids and alkyl (ether) phosphates.

Suitable further anionic surfactants are also anionic gemini surfactants having a diphenyl oxide basic structure, 2 sulfonate groups and an alkyl radical on one or both benzene rings according to the formula ⁻O₃S(C₆H₃R)O(C₆H₃R′)SO₃⁻, in which R stands for an alkyl radical having, for example, 6, 10, 12 or 16 carbon atoms and R′ stands for R or H (Dowfax® Dry hydrotropes Powder with C₁₆ alkyl radical(s); INCI Sodium Hexyldiphenyl Ether Sulfonate, Disodium Decyl Phenyl Ether Disulfonate, Disodium Lauryl Phenyl Ether Disulfonate, Disodium Cetyl Phenyl Ether Disulfonate) and fluorinated anionic surfactants, in particular perfluorinated alkylsulfonates such as ammonium C_{9/10} perfluoroalkyl sulfonate (Fluorad® FC 120) and perfluorooctane sulfonic acid potassium salt (Fluorad® FC 95), wherein a content of fluorine compounds in the washing or cleaning agents as contemplated herein is less preferred.

Particularly preferred further anionic surfactants are the anionic sulfosuccinic acid surfactants sulfosuccinates, sulfosuccinamates and sulfosuccinamides, in particular sulfosuccinates and sulfosuccinamates, most preferably sulfosuccinates. The sulfosuccinates are the salts of the monoesters and diesters of sulfosuccinic acid HOOCCH(SO₃H)CH₂COOH, while the sulfosuccinamates are understood to mean the salts of the monoamides of sulfosuccinic acid and the sulfosuccinamides are understood to mean the salts of the diamides of sulfosuccinic acid. The salts are preferably alkali metal salts, ammonium salts and mono-, di- or trialkanolammonium salts, for example, mono-, di- or triethanolammonium salts, in particular lithium, sodium, potassium or ammonium salts, particularly preferably sodium or ammonium salts, most preferably sodium salts.

In a particular embodiment, the agent as contemplated herein contains as anionic sulfosuccinic acid surfactants one or more sulfosuccinates, sulfosuccinamates and/or sulfosuccinamides, preferably sulfosuccinates and/or sulfosuccinamates, in particular sulfosuccinates, in an amount of usually from about 0.001 to about 5% by weight, preferably from about 0.01 to about 4% by weight, in particular from about 0.1 to about 3% by weight, particularly preferably from about 0.2 to about 2% by weight, most preferably from about 0.5 to about 1.5% by weight, for example, about 1% by weight.

Further usable anionic surfactants are the alkyl sulfates of the formula

R²—O—SO₃⁻X⁺ (III).

In this formula (III), R² stands for a linear or branched, substituted or unsubstituted alkyl radical, preferably a linear, unsubstituted alkyl radical, more preferably a fatty alcohol radical. Preferred radicals R² are selected from decyl, undecyl, dodecyl, tridecyl, tetradecyl, pentadecyl, hexadecyl, heptadecyl, octadecyl, nonadecyl, eicosyl radicals and mixtures thereof, wherein the representatives with an even number of carbon atoms are preferred. Particularly preferred radicals R² are derived from C₁₂-C₁₈ fatty alcohols, for example, coconut fatty alcohol, tallow fatty alcohol, lauryl, myristyl, cetyl or stearyl alcohol or C₁₀-C₂₀ oxo alcohols. Y stands for a monovalent cation or the n-th part of an n-valent cation, the alkali metal ions being preferred, and Na⁺ or K⁺ being preferred, wherein Na⁺ is extremely preferred. Further cations Y+ can be selected from NH₄⁺, ½ Zn²⁺, ½ Mg²⁺, ½ Ca²⁺, ½ Mn²⁺, n and mixtures thereof.

In various embodiments, these surfactants are selected from fatty alcohol sulfates of formula A-3

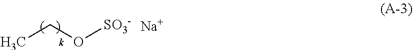

with k=11 to 19. Very particularly preferred representatives are Na—C₁₂₋₁₄ fatty alcohol sulfates (k=11-13 in formula A-3).

The anionic surfactants are usually used as an alkali metal, alkaline earth metal and/or mono-, di- or trialkanolammonium salt and/or but also in the form of their corresponding acid to be neutralized with the corresponding alkali metal hydroxide, alkaline earth metal hydroxide and/or mono-, di- or trialkanolamine in situ. Preference is given here as alkali metals potassium and sodium in particular, as alkaline earth metals calcium and magnesium in particular, and as alkanolamines mono-, di- or triethanolamine. Particularly preferred are the sodium salts.

The amphoteric surfactants (amphoteric surfactants, zwitterionic surfactants) which can be used as contemplated herein include alkylamidoalkylamines, alkyl-substituted amino acids, acylated amino acids or biosurfactants, of which the betaines are preferred within the scope of the teaching as contemplated herein.

Suitable betaines, which are mainly used in manual dishwashing washing agents, are the alkylbetaines, the alkylamidobetaines, the imidazolinium betaines, the sulfobetaines (INCI Sultaines) and the phosphobetaines and preferably satisfy formula IV,

R¹—[CO—X—(CH₂)ₙ]ₓ—N⁺(R²)(R³)—(CH₂)ₘ—[CH(OH)—CH₂]_{y}—Y⁻ (IV)

in which R¹ is a saturated or unsaturated C₆₋₂₂ alkyl radical, preferably C₈₋₁₈ alkyl radical, in particular a saturated C₁₀₋₁₆alkyl radical, for example, a saturated C₁₂₋₁₄ alkyl radical,
X is NH, NR⁴ with the C₁₋₄ alkyl radical R⁴, O or S,
n is a number from 1 to about 10, preferably from 2 to about 5, in particular 3,
x is 0 or 1, preferably 1,
R², R³ are independently of one another C₁₋₄ alkyl radical, possibly hydroxy-substituted, for example, a hydroxyethyl radical, but in particular a methyl radical,
m is a number from 1 to about 4, in particular 1, 2 or 3,
y is 0 or 1 and
Y is COO, SO₃, OPO(OR⁵)O or P(O)(OR⁵)O, wherein R⁵ is a hydrogen atom H or a C₁₋₄ alkyl radical.

The alkyl and alkylamido betaines, betaines of the formula I having a carboxylate group (Y⁻═COO⁻) are also called carbobetaines.

Preferred betaines are the alkylbetaines of the formula (Ia), the alkylamidobetaines of the formula (IVb), the sulfobetaines of the formula (IVc) and the amidosulfobetaines of the formula (IVd),

R¹—N⁺(CH₃)₂—CH₂COO⁻ (IVa)

R¹—CO—NH—(CH₂)₃—N⁺(CH₃)₂—CH₂COO⁻ (IVb)

R¹—N⁺(CH₃)₂—CH₂CH(OH)CH₂SO₃⁻ (IVc)

R¹—CO—NH—(CH₂)₃—N⁺(CH₃)₂—CH₂CH(OH)CH₂SO₃⁻ (IVd)

in which R¹ has the same meaning as in formula I.

Particularly preferred betaines are the carbobetaines, in particular the carbobetaines of the formula (IVa) and (IVb), most preferably the alkylamidobetaines of the formula (IVb).

The agent as contemplated herein can contain one or more betaines in an amount of usually from about 1 to about 15% by weight, preferably from about 3 to about 10% by weight, in particular from about 4 to about 8% by weight.

The alkylamidoalkylamines (INCI Alkylamido Alkylamines) are amphoteric surfactants of the formula (V),

R⁹—CO—NR¹⁰—(CH₂)ᵢ—N(R¹¹)—(CH₂CH₂O)ⱼ—(CH₂)ₖ—[CH(OH)]ₗ—CH₂—Z—OM (V)

in which R⁹ is a saturated or unsaturated C₆₋₂₂ alkyl radical, preferably C₈₋₁₈ alkyl radical, in particular a saturated C₁₀₋₁₆alkyl radical, for example, a saturated C₁₂₋₁₄ alkyl radical,
R¹⁰ is a hydrogen atom H or a C₁₋₄ alkyl radical, preferably H,
i is a number from 1 to about 10, preferably from 2 to about 5, in particular 2 or 3,
R¹¹ is a hydrogen atom H or CH₂COOM (for M, see below),
j is a number from 1 to about 4, preferably 1 or 2, in particular 1,
k is a number from 0 to about 4, preferably 0 or 1,
l is 0 or 1, wherein k=1 when l=1,
Z is CO, SO₂, OPO(OR¹²) or P(O)(OR¹²), wherein R¹² is a C₁₋₄ alkyl radical or M (see below), and
M is a hydrogen, an alkali metal, an alkaline earth metal or a protonated alkanolamine, for example, protonated mono-, di- or triethanolamine.

Preferred representatives satisfy the formulas Va to Vd,

R⁹—CO—NH—(CH₂)₂—N(R¹¹)—CH₂CH₂O—CH₂—COOM (Va)

R⁹—CO—NH—(CH₂)₂—N(R¹¹)—CH₂CH₂O—CH₂CH₂—COOM (Vb)

R⁹—CO—NH—(CH₂)₂—N(R¹¹)—CH₂CH₂O—CH₂CH(OH)CH₂—SO₃M (Vc)

R⁹—CO—NH—(CH₂)₂—N(R¹¹)—CH₂CH₂O—CH₂CH(OH)CH₂—OPO₃HM (Vd)

in which R¹¹ and M have the same meaning as in formula (V).

Alkyl-substituted amino acids (INCI Alkyl-Substituted Amino Acids) which are preferred as contemplated herein are monoalkyl-substituted amino acids of the formula (VI),

R¹³—NH—CH(R¹⁴)—(CH₂)ᵤ—COOM′ (VI)

in which R¹³ is a saturated or unsaturated C₆₋₂₂ alkyl radical, preferably C₈₋₁₈ alkyl radical, in particular a saturated C₁₀₋₁₆alkyl radical, for example, a saturated C₁₂₋₁₄ alkyl radical,
R¹⁴ is a hydrogen atom H or a C₁₋₄ alkyl radical, preferably H,
u is a number from 0 to about 4, preferably 0 or 1, in particular 1, and
M′ is a hydrogen, an alkali metal, an alkaline earth metal or a protonated alkanolamine, for example, protonated mono-, di- or triethanolamine,
alkyl-substituted imino acids according to formula (VII),

R¹⁵—N—[(CH₂)ᵥ—COOM″]₂ (VII)

in which R¹⁵ is a saturated or unsaturated C₆₋₂₂ alkyl radical, preferably C₈₋₁₈ alkyl radical, in particular a saturated C₁₀₋₁₆alkyl radical, for example, a saturated C₁₂₋₁₄ alkyl radical,
v is a number from 1 to about 5, preferably 2 or 3, in particular 2, and
M″ is a hydrogen, an alkali metal, an alkaline earth metal or a protonated alkanolamine, for example, protonated mono-, di- or triethanolamine, wherein M″ can have in the two carboxy groups the same or two different meanings, for example, can be hydrogen and sodium or can be twice sodium,
and mono- or dialkyl-substituted natural amino acids according to formula (VIII),

R¹⁶—N(R¹⁷)—CH(R¹⁸)—COOM′″ (VIII)

in which R¹⁶ is a saturated or unsaturated C₆₋₂₂ alkyl radical, preferably C₈₋₁₈ alkyl radical, in particular a saturated C₁₀₋₁₆alkyl radical, for example, a saturated C₁₂₋₁₄ alkyl radical,
R¹⁷ is a hydrogen atom or a C₁₋₄ alkyl radical, optionally hydroxyl or amine-substituted, for example, a methyl, ethyl, hydroxyethyl or amine propyl radical,
R¹⁸ is the residue of one of the 20 natural α-amino acids H₂NCH(R¹⁸)COOH, and
M′″ is a hydrogen, an alkali metal, an alkaline earth metal or a protonated alkanolamine, for example, protonated mono-, di- or triethanolamine.

Particularly preferred alkyl-substituted amino acids are the aminopropionates of the formula (VIa),

R¹³—NH—CH₂CH₂COOM′ (VIa)

in which R¹³ and M′ have the same meaning as in formula (VI).

Acylated amino acids are amino acids, in particular the 20 natural α-amino acids, which carry on the amino nitrogen atom the acyl radical R¹⁹CO of a saturated or unsaturated fatty acid R¹⁹COOH, where R¹⁹ is a saturated or unsaturated C₆₋₂₂ alkyl radical, preferably C₈₋₁₈ alkyl radical, in particular a saturated C₁₀₋₁₆ alkyl radical, for example, a saturated C₁₂₋₁₄ alkyl radical. The acylated amino acids can also be used as the alkali metal salt, alkaline earth metal salt or alkanolammonium salt, for example, mono-, di- or triethanolammonium salt. Exemplary acylated amino acids are the acyl derivatives summarized in accordance with INCI under Amino Acids, for example, Sodium Cocoyl Glutamate, Lauroyl Glutamic Acid, Capryloyl Glycine or Myristoyl Methylalanine.

In a particular embodiment as contemplated herein, a combination of two or more different amphoteric surfactants is used, in particular a binary amphoteric surfactant combination.

The amphoteric surfactant combination preferably contains at least one betaine, in particular at least one alkylamidobetaine, more preferably cocoamidopropylbetaine.

In a further particular embodiment, the agent as contemplated herein contains one or more amphoteric surfactants in an amount of more than about 8% by weight. In a further particular embodiment, the agent as contemplated herein contains one or more amphoteric surfactants in an amount of less than about 2% by weight.

The nonionic surfactants used are preferably alkoxylated, advantageously ethoxylated, in particular primary, alcohols having preferably from about 8 to about 18 C atoms and on average from about 1 to about 12 moles of ethylene oxide (EO) per mole of alcohol, in which the alcohol radical can be linear or preferably methyl-branched in the 2-position or can contain linear and methyl-branched radicals in the mixture, as they are usually present in oxo alcohol radicals. In particular, however, alcohol ethoxylates with linear radicals of alcohols of native origin having from about 12 to about 18 C atoms, for example, of coconut, palm, tallow or oleyl alcohol, and on average from about 2 to about 8 EO per mole of alcohol are preferred. The preferred ethoxylated alcohols include, for example, C₁₂₋₁₄ alcohols with about 3 EO, about 4 EO or about 7 EO, C₉₋₁₁ alcohols with about 7 EO, C₁₃₋₁₅ alcohols with about 3 EO, about 5 EO, about 7 EO or about 8 EO, C₁₂₋₁₈ alcohols with about 3 EO, about 5 EO or about 7 EO and mixtures of these, such as mixtures of C₁₂₋₁₄ alcohol with about 3 EO and C₁₂₋₁₈ alcohol with about 7 EO. The degrees of ethoxylation specified represent statistical means which, for a particular product, can be an integer or a fractional number. Preferred alcohol ethoxylates have a narrow homolog distribution (narrow range ethoxylates, NRE). In addition to these nonionic surfactants, fatty alcohols with more than about 12 EO can also be used. Examples include tallow fatty alcohol with about 14 EO, about 25 EO, about 30 EO or about 40 EO. Nonionic surfactants containing EO and PO groups together in the molecule can also be used as contemplated herein. More preferably, the cleaning agent for hard surfaces contains a C₁₂₋₁₈ fatty alcohol with about 7 EO or a C₁₃₋₁₅ oxo alcohol with about 7 EO as the nonionic surfactant.

The content of nonionic surfactants in the cleaning agent is preferably from about 1 to about 30% by weight and preferably from about 2 to about 25% by weight, in each case based on the total cleaning agent.

These nonionic surfactants, in combination with an amine oxide, have good cleaning performance on grease-soiled hard surfaces such as dishes.

Nonionic surfactants in the context of the present disclosure are alkoxylates but also alkylphenol polyglycol ethers, end-capped polyglycol ethers, mixed ethers and hydroxy mixed ethers and fatty acid polyglycol esters. Also suitable are block polymers of ethylene oxide and propylene oxide and fatty acid alkanolamides and fatty acid polyglycol ethers. Important classes of nonionic surfactants as contemplated herein are furthermore the amine oxides and the sugar surfactants, in particular the alkyl polyglucosides.

The amine oxides suitable as contemplated herein include alkylamine oxides, in particular alkyldimethylamine oxides, alkylamidoamine oxides and alkoxyalkylamine oxides. Preferred amine oxides satisfy formula IX,

R⁶R⁷R⁸N⁺—O⁻ (IX)

R⁶—[CO—NH—(CH₂)_{w}]_{z}—N⁺(R⁷)(R⁸)—O⁻ (IX)

in which R⁶ is a saturated or unsaturated C₆₋₂₂ alkyl radical, preferably C₈₋₁₈ alkyl radical, in particular a saturated C₁₀₋₁₆ alkyl radical, for example, a saturated C₁₂₋₁₄ alkyl radical which is bound in the alkylamidoamine oxides via a carbonylamidoalkylene group —CO—NH—(CH₂)_{z}— and in the alkylamidoamine oxides via an oxaalkylene group —O—(CH₂)_{z}— to the nitrogen atom N, wherein z in each case stands for a number from 1 to about 10, preferably from 2 to about 5, in particular 3,
R⁷, R⁸ are independently of each other a C₁₋₄ alkyl radical, optionally hydroxy-substituted, such as a hydroxyethyl radical, in particular a methyl radical.

The content of amine oxide in the cleaning agent is preferably from about 1 to about 15% by weight and preferably from about 2 to about 10% by weight, in each case based on the total cleaning agent.

Sugar surfactants are known surface-active compounds, which include, for example, the sugar surfactant classes of the alkyl glucose esters, aldobionamides, gluconamides (sugar acid amides), glycerolamides, glycerol glycolipids, polyhydroxy fatty acid amide sugar surfactants (sugar amides) and alkyl polyglycosides. Preferred sugar surfactants within the context of the teaching as contemplated herein are the alkyl polyglycosides and the sugar amides and their derivatives, in particular their ethers and esters. The ethers are the products of the reaction of one or more, preferably one, sugar hydroxy group with a compound containing one or more hydroxy groups, for example, C₁₋₂₂ alcohols or glycols such as ethylene and/or propylene glycol, wherein the sugar hydroxy group can also carry polyethylene glycol and/or polypropylene glycol. The esters are the reaction products of one or more, preferably one, sugar hydroxy group with a carboxylic acid, in particular a C₆₋₂₂ fatty acid.

Particularly preferred sugar amides satisfy the formula R′C(O)N(R″)[Z], in which R′ stands for a linear or branched, saturated or unsaturated acyl radical, preferably a linear unsaturated acyl radical, having from about 5 to about 21, preferably from about 5 to about 17, in particular from about 7 to about 15, particularly preferably from about 7 to about 13 carbon atoms, R″ stands for a linear or branched, saturated or unsaturated alkyl radical, preferably a linear unsaturated alkyl radical, having from about 6 to about 22, preferably from about 6 to about 18, in particular from about 8 to about 16, particularly preferred from about 8 to about 14 carbon atoms, a C₁₋₅ alkyl, in particular a methyl, ethyl, propyl, isopropyl, n-butyl, isobutyl, tert-butyl or n-pentyl radical, or hydrogen and Z stands for a sugar radical, that is, a monosaccharide radical. Particularly preferred sugar amides are the amides of glucose, the glucamides, for example, lauroyl-methyl-glucamide.

The alkyl polyglycosides (APG) are particularly preferred sugar surfactants within the context of the teaching as contemplated herein. They are known substances that can be obtained according to the relevant methods of preparative organic chemistry. They preferably satisfy the general formula RⁱO(AO)ₐ[G]ₓ, in which Rⁱ stands for a linear or branched, saturated or unsaturated alkyl radical having from about 6 to about 22, preferably from about 6 to about 18, in particular from about 8 to about 16, particularly preferably from about 8 to about 14 carbon atoms, [G] stands for a glycosidically linked sugar radical preferably xylose, but in particular glucose, and AO for an alkyleneoxy group, for example, an ethyleneoxy or propyleneoxy group, and a for the average degree of alkoxylation from 0 to about 20. In this case, the group (AO)ₐ can also contain different alkyleneoxy units, for example, ethyleneoxy or propyleneoxy units, wherein in which case a is the average total degree of alkoxylation, that is, the sum of degree of ethoxylation and degree of propoxylation. The index number x indicates the degree of oligomerization (DP degree), that is, the distribution of mono- and oligoglycosides, and stands for a number between about 1 and about 10. While x in a given compound always has to be an integer, and here above can assume all the values x=from 1 to about 6, the value x for a given alkyl glycoside is an analytically determined arithmetic quantity, which usually represents a fractional number. Preferably, alkyl glycosides having a mean degree of oligomerization x of from about 1.1 to about 3.0 are used. From an application point of view, those alkyl glycosides whose degree of oligomerization is less than about 1.7 and in particular between about 1.2 and about 1.6 are preferred. Unless stated below or otherwise, the alkyl radicals Rⁱ of the APG are linear unsaturated radicals having the stated number of carbon atoms.

The alkyl or alkenyl radical Rⁱ can be derived from primary alcohols having from about 8 to about 18, preferably from about 8 to about 14 carbon atoms. Typical examples are caproic alcohol, caprylic alcohol, capric alcohol and undecyl alcohol and technical mixtures thereof, for example, as obtained in the course of the hydrogenation of technical fatty acid methyl esters or in the course of the hydrogenation of aldehydes from Roelen's oxosynthesis.

Preferably, however, the alkyl or alkenyl radical Rⁱ is derived from lauryl alcohol, myristyl alcohol, cetyl alcohol, palmoleyl alcohol, stearyl alcohol, isostearyl alcohol or oleyl alcohol. Also to be mentioned are elaidyl alcohol, petroselinyl alcohol, arachidyl alcohol, gadoleyl alcohol, behenyl alcohol, erucyl alcohol and technical mixtures thereof.

Particularly preferred APG are not alkoxylated (a=0) and satisfy the formula RO[G]ₓ, in which R is as previously described stands for a linear or branched, saturated or unsaturated alkyl radical having from about 4 to about 22 carbon atoms, [G] stands for a glycosidically linked sugar radical, preferably glucose radical, and x is a number from about 1 to about 10, preferably from about 1.1 to about 3, in particular from about 1.2 to about 1.6. Accordingly, preferred alkyl polyglycosides are, for example, C₈₋₁₀ and a C₁₂₋₁₄ alkylpolyglucoside having a DP degree of 1.4 or 1.5, in particular C₈₋₁₀ alkyl-1,5-glucoside and C₁₂₋₁₄ alkyl-1,4-glucoside.

The agent as contemplated herein can additionally contain one or more cationic surfactants (cationic surfactants, INCI Quaternary Ammonium Compounds), usually in an amount of from about 0.001 to about 5% by weight, preferably from about 0.01 to about 4% by weight, in particular from about 0.1 to about 3% by weight, particularly preferably from about 0.2 to about 2% by weight, most preferably from about 0.5 to about 1.5% by weight, for example, about 1% by weight.

Preferred cationic surfactants are the quaternary surface-active compounds, in particular having an ammonium, sulfonium, phosphonium, iodonium or arsonium group, which are also known as antimicrobial active ingredients. Through the use of quaternary surface-active compounds having antimicrobial action, the agent can be designed with an antimicrobial effect or its possibly existing antimicrobial effect due to other ingredients can be improved.

Particularly preferred cationic surfactants are the quaternary ammonium compounds (QAV, INCI Quaternary Ammonium Compounds) according to the general formula (R^{I})(R^{II})(R^{III})(R^{IV})N⁺X⁻, in which R^{I} to R^{IV} represent the same or various C₁₋₂₂ alkyl radicals, C₇₋₂₈ aralkyl radicals or heterocyclic radicals, wherein two or in the case of an aromatic inclusion as in pyridine even three radicals together with the nitrogen atom, form the heterocycle, for example, a pyridinium or compound, and X⁻ are halide ions, sulfate ions, hydroxide ions or similar anions. For optimum antimicrobial activity, preferably at least one of the radicals has a chain length of from about 8 to about 18, in particular from about 12 to about 16, C atoms.

QACs can be prepared by reacting tertiary amines with alkylating agents, such as, for example, methyl chloride, benzyl chloride, dimethyl sulfate, dodecyl bromide, but also ethylene oxide. The alkylation of tertiary amines with a long alkyl radical and two methyl groups is particularly easy, the quaternization of tertiary amines with two long radicals and one methyl group can also be carried out with the aid of methyl chloride under mild conditions. Amines having three long alkyl radicals or hydroxy-substituted alkyl radicals are less reactive and are preferably quaternized with dimethyl sulfate.

In order to avoid possible incompatibilities of the cationic surfactants with the anionic surfactants present as contemplated herein, as much as possible anionic surfactant-compatible and/or as little as possible cationic surfactants are preferably used or, in a particular embodiment as contemplated herein, cationic surfactants are completely dispensed with.

An agent as contemplated herein, in particular washing or cleaning agent, can contain at least one water-soluble and/or water-insoluble, organic and/or inorganic builder.

The general builders that can be used in particular include the aminocarboxylic acids and their salts, zeolites, silicates, carbonates and organic (co)builders. Preferably, the agents are phosphate-free.

The water-soluble organic builder substances include polycarboxylic acids, in particular citric acid and sugar acids, monomeric and polymeric aminopolycarboxylic acids, in particular methylglycinediacetic acid, glutaminediacetic acid, nitrilotriacetic acid and ethylenediaminetetraacetic acid and polyaspartic acid, polymeric hydroxy compounds such as dextrin and also polymeric (poly)carboxylic acids, polymeric acrylic acids, methacrylic acids, maleic acids and mixed polymers of these, which can also contain polymerized small amounts of polymerizable substances without carboxylic acid functionality. Suitable, although less preferred, compounds of this class are copolymers of acrylic or methacrylic acid with vinyl ethers, such as vinylmethyl ethers, vinyl esters, ethylene, propylene and styrene, in which the acid content is at least about 50% by weight. The organic builder substances can be used, in particular for the preparation of liquid agents, in the form of aqueous solutions, preferably in the form of from about 30 to about 50 percent by weight aqueous solutions. All of the acids mentioned are generally used in the form of their water-soluble salts, in particular their alkali metal salts.

Organic builder substances can, if desired, be included in amounts of up to about 40% by weight, more preferably up to about 25% by weight, and preferably from about 1% to about 8% by weight.

In particular, alkali metal silicates are considered as water-soluble inorganic builder materials. In particular, crystalline or amorphous alkali metal aluminosilicates can be used as water-insoluble, water-dispersible inorganic builder materials, if desired, in amounts of up to about 50% by weight, preferably not more than about 40% by weight and in liquid agents, in particular from about 1% by weight to about 5% by weight. Preferred among these are the washing agent grade crystalline sodium aluminosilicates, in particular zeolite A, P and optionally X. Amounts near the above upper limit are preferably used in solid, particulate agents. In particular, suitable aluminosilicates have no particles having a particle size greater than about 30 μm and preferably include at least about 80% by weight of particles having a size of less than about 10 μm.

Suitable substitutes or partial substitutes for said aluminosilicate are crystalline alkali silicates which can be present alone or in a mixture with amorphous silicates. The alkali metal silicates useful as builders in the agents as contemplated herein preferably have a molar ratio of alkali metal oxide to SiO₂ below about 0.95, in particular from about 1:1.1 to about 1:12, and can be present in amorphous or crystalline form. Preferred alkali metal silicates are the sodium silicates, in particular the amorphous sodium silicates, having a molar ratio of Na₂O:SiO₂ of from about 1:2 to about 1:2.8. Preferably, crystalline phyllosilicates of the general formula Na₂SiₓO₂ₓ₊₁.y H₂O are used as crystalline silicates which can be present alone or in a mixture with amorphous silicates, in which x, the so-called modulus, is a number from about 1.9 to about 4 and y is a number from 0 to about 20 and preferred values for x are 2, 3 or 4. Preferred crystalline phyllosilicates are those in which x in the abovementioned general formula assumes the values 2 or 3. In particular, both beta and delta-sodium silicates (Na₂Si₂O₅.y H₂O) are preferred. Practically anhydrous crystalline alkali silicates of the abovementioned general formula prepared from amorphous alkali silicates can also be used in agents as contemplated herein, where x in the formula means a number from about 1.9 to about 2.1. In a further preferred embodiment of the agent as contemplated herein, a crystalline sodium layer silicate, as can be prepared from sand and soda, having a modulus of from about 2 to about 3 is used. Crystalline sodium silicates having a modulus in the range from about 1.9 to about 3.5 are used in a further preferred embodiment of agents as contemplated herein. If alkali metal aluminosilicate, in particular zeolite, is also present as an additional builder substance, the weight ratio of aluminosilicate to silicate, is preferably from about 1:10 to about 10:1, based in each case on anhydrous active substances. In agents containing both amorphous and crystalline alkali metal silicates, the weight ratio of amorphous alkali metal silicate to crystalline alkali metal silicate is preferably from about 1:2 to about 2:1 and in particular from about 1:1 to about 2:1.

Inorganic builder substances are, if desired, preferably present in the compositions as contemplated herein in amounts of up to about 60% by weight, in particular from about 1% by weight to about 10% by weight.

Washing or cleaning agents as contemplated herein can contain other enzymes in addition to the amylase. These can be hydrolytic enzymes or other enzymes in a concentration practical for the effectiveness of the agent. One embodiment as contemplated herein thus represents agents comprising one or more enzymes. Enzymes preferred for use are all enzymes which can develop a catalytic activity in the agent as contemplated herein, in particular a protease, amylases distinguishable from the amylase according to SEQ ID NO:1, a cellulase, hemicellulase, mannanase, tannase, xylanase, xanthanase, xyloglucanase, β-glucosidase, pectinase, carrageenase, perhydrolase, oxidase, oxidoreductase or a lipase, and mixtures thereof. The additional enzyme is, as described above, preferably a protease. Enzymes are advantageously present in the agent in each case in an amount of 1×10⁻⁸ to 5% by weight based on active protein. More preferably, each enzyme is present in an amount of 1×10⁻⁷-3% by weight, from about 0.00001 to about 1% by weight, from about 0.00005 to about 0.5% by weight, from about 0.0001 to about 0.1% by weight and particularly preferably from about 0.0001 to about 0.05% by weight in agents as contemplated herein, based on active protein. Particularly preferably, the enzymes show synergistic cleaning performance against certain soilings or stains, that is, the enzymes contained in the agent composition mutually support each other in their cleaning performance. Synergistic effects can occur not only between different enzymes, but also between one or more enzymes and further ingredients of the agent as contemplated herein.

The further amylase(s) is/are preferably an α-amylase. The hemicellulase is preferably a β-glucanase, a pectinase, a pullulanase and/or a mannanase. The cellulase is preferably a cellulase mixture or a one-component cellulase, preferably or predominantly an endoglucanase and/or a cellobiohydrolase. The oxidoreductase is preferably an oxidase, in particular a choline oxidase, or a perhydrolase.

The proteases used are preferably alkaline serine proteases. They act as nonspecific endopeptidases, that is, they hydrolyze any acid amide bonds that are located inside peptides or proteins and thereby cause degradation of proteinaceous soilings on the items to be cleaned. Their pH optimum is usually in the clearly alkaline range.

The protein concentration can be determined with the help of known methods, for example, the BCA method (bicinchoninic acid, 2,2′-biquinolyl-4,4′-dicarboxylic acid) or the biuret method. The determination of the active protein concentration is carried out in this regard via a titration of the active sites using a suitable irreversible inhibitor (for proteases, for example, phenylmethylsulfonyl fluoride (PMSF)) and determination of the residual activity (compare M. Bender et al., J. Am. Chem. Soc. 88, 24 (1966), p. 5890-5913).

The enzymes to be used can further be formulated together with adjuncts, for example, from fermentation, in the agents described herein. In liquid formulations, the enzymes are preferably used as enzyme liquid formulation(s).

The enzymes are usually not provided in the form of the pure protein, but rather in the form of stabilized, storable and transportable preparations. Such prefabricated preparations include, for example, the solid preparations obtained by granulation, extrusion or lyophilization or, in particular in the case of liquid or gel-form agents, solutions of the enzymes, advantageously as concentrated as possible, low in water and/or added with stabilizers or further auxiliaries.

Alternatively, the enzymes can be encapsulated for both the solid and liquid dosage forms, for example, by spray-drying or extruding the enzyme solution together with a preferably natural polymer or in the form of capsules, for example, those in which the enzymes are enclosed as in a solidified gel or in those of the core-shell type, in which an enzyme-containing core is coated with a water, air and/or chemical impermeable protective layer. Additional active ingredients, for example, stabilizers, emulsifiers, pigments, bleaches or dyes, can additionally be applied in deposited layers. Such capsules are applied by methods known per se, for example, by shaking or rolling granulation or in fluid-bed processes. Advantageously, such granules are low in dust and storage stable due to the coating, for example, by applying polymeric film-forming agents.

Furthermore, it is possible to formulate two or more enzymes together so that a single granule has a plurality of enzyme activities.

The agent as contemplated herein can have one or more enzyme stabilizers in various embodiments. Therefore, the agent as contemplated herein can further contain an enzyme stabilizer, for example, selected from the group of sodium formate, sodium sulfate, lower aliphatic alcohols and boric acid and their esters and salts. Of course, two or more of these compounds can be used in combination. The salts of the compounds mentioned can also be used in the form of hydrates, such as, sodium sulfate decahydrate.

The term “lower aliphatic alcohols”, as used herein, includes monoalcohols, diols, and higher alcohols having up to about 6 carbon atoms. Polyols, for example, glycerol, (mono)ethylene glycol, (mono)propylene glycol or sorbitol can be mentioned as belonging to the group of lower aliphatic alcohols in this context, without the present disclosure being restricted thereto.

In addition to the at least one enzyme stabilizer selected from the above group, an agent as contemplated herein can also contain at least one further stabilizer. Such stabilizers are known in the prior art.

Reversible protease inhibitors protect the enzymes contained in a washing or cleaning agent from proteolytic degradation by reversibly inhibiting the enzymatic activity of the proteases contained in the agent. Boronic acids or their salts or esters are frequently used as reversible protease inhibitors benzamidine hydrochloride, including primarily derivatives having aromatic groups, such as ortho-, meta- or para-substituted phenylboronic acids, in particular 4-formylphenyl-boronic acid, or the salts or esters of said compounds. Also, peptide aldehydes, that is, oligopeptides having a reduced C-terminus, in particular those of from about 2 to about 50 monomers, are used for this purpose. The peptidic reversible protease inhibitors include, among others, ovomucoid and leupeptin.

Further enzyme stabilizers are amino alcohols such as mono-, di-, triethanol- and -propanolamine and mixtures thereof, aliphatic carboxylic acids up to C₁₂, such as succinic acid, other dicarboxylic acids or salts of said acids. End-capped fatty acid amide alkoxylates are also suitable for this purpose. Some organic acids used as builders are also able to stabilize an enzyme. Calcium and/or magnesium salts, such as calcium acetate, are also used for this purpose.

Polyamide oligomers or polymeric compounds such as lignin, water-soluble vinyl copolymers or cellulose ethers, acrylic polymers and/or polyamides stabilize the enzyme preparation, among other things, against physical influences or pH fluctuations. Polymers that contain polyamine N-oxide act simultaneously as enzyme stabilizers and as dye transfer inhibitors. Other polymeric stabilizers are linear C₈-C₁₈ polyoxyalkylenes. Alkylpolyglycosides can also stabilize the enzymatic components of the agent as contemplated herein and, preferably, are capable of additionally increasing their performance. Crosslinked N-containing compounds preferably fulfill a dual function as soil release agents and as enzyme stabilizers. Hydrophobic, nonionic polymer stabilizes, in particular, an optionally contained cellulase.

Reducing agents and antioxidants increase the stability of the enzymes to oxidative degradation; for example, sulfur-containing reducing agents are common for this purpose, for example, sodium sulfite and reducing sugars.

In one embodiment, the agents according to the present disclosure are liquid and contain water as the main solvent, that is, they are aqueous agents. The water content of the aqueous agent as contemplated herein is usually from about 15 to about 70% by weight, preferably from about 20 to about 60% by weight. In various embodiments, the water content is more than about 5% by weight, preferably more than about 15% by weight and particularly preferably more than about 50% by weight, each based on the total amount of agent.

In addition, nonaqueous solvents can be added to the agent. Suitable non-aqueous solvents include mono- or polyhydric alcohols, alkanolamines or glycol ethers, provided that they are miscible with water in the specified concentration range. Preferably, the solvents are selected from ethanol, n-propanol, i-propanol, butanols, glycol, propanediol, butanediol, methylpropanediol, glycerol, diglycol, propyldiglycol, butyldiglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol monomethyl ether, dipropylene glycol monoethyl ether, methoxytriglycol, ethoxytriglycol, butoxytriglycol, 1-butoxyethoxy-2-propanol, 3-methyl-3-methoxybutanol, propylene glycol t-butyl ether, di-n-octyl ether and mixtures of these solvents.

The one or more non-aqueous solvents is/are usually contained in an amount of from about 0.1 to about 10% by weight, preferably from about 1 to about 8% by weight, based on the total composition.

In addition to the components mentioned so far, the agents as contemplated herein can contain further ingredients which further improve the technical performance and/or aesthetic properties of the cleaning agent. These include, for example, additives for improving the flow and drying behavior, for adjusting the viscosity and/or for stabilization, and other cleaning agents and additives customary in cleaning agents, such as UV stabilizers, perfume, pearlescing agents, dyes, corrosion inhibitors, preservatives, buttering substances, organic salts, disinfectants, structuring polymers, defoamers, encapsulated ingredients (for example, encapsulated perfume), pH adjusters and additives to nourish skin or improve feel.

Polymeric thickeners in the context of the present disclosure are the polycarboxylates acting as thickening polyelectrolytes, preferably homo- and copolymerisates of acrylic acid, in particular acrylic acid copolymers such as acrylic acid-methacrylic acid copolymers, and the polysaccharides, in particular heteropolysaccharides, and other conventional thickening polymers.

Suitable polysaccharides or heteropolysaccharides are the polysaccharide gums, for example, gum arabic, agar, alginates, carrageenans and their salts, guar, guar gum, tragacanth, gellan, ramzan, dextran or xanthan and their derivatives, for example, propoxylated guar, and also their mixtures. Other polysaccharide thickeners, such as starches or cellulose derivatives, can alternatively or preferably be used in addition to a polysaccharide gum, for example, starches of various origins and starch derivatives, for example, hydroxyethyl starch, starch phosphate esters or starch acetates, or carboxymethylcellulose or its sodium salt, methyl, ethyl, hydroxyethyl, hydroxypropyl, hydroxypropyl methyl or hydroxyethyl methyl cellulose or cellulose acetate.

Acrylic acid polymers suitable as polymeric thickeners are, for example, high molecular weight homopolymers of acrylic acid crosslinked with a polyalkenyl polyether, in particular an allyl ether of sucrose, pentaerythritol or propylene (INCI Carbomer), which are also referred to as carboxyvinyl polymers.

However, particularly suitable polymeric thickeners are the following acrylic acid copolymers: (i) copolymers of two or more monomers from the group of acrylic acid, methacrylic acid and their simple esters, preferably formed with C₁₋₄ alkanols (INCI Acrylates Copolymer), which includes, for example, the copolymers of methacrylic acid, butyl acrylate and methyl methacrylate (CAS 25035-69-2) or of butyl acrylate and methyl methacrylate (CAS 25852-37-3); (ii) crosslinked high molecular weight acrylic acid copolymers, which include, for example, copolymers of C₁₀₋₃₀ alkyl acrylates crosslinked with an allyl ether of saccharose or pentaerythritol having one or more monomers from the group of acrylic acid, methacrylic acid and their simple esters, preferably formed with C₁₋₄ alkanols (INCI Acrylates/C₁₀₋₃₀ Alkyl Acrylate Crosspolymer).

The content of polymeric thickener is usually not more than about 8% by weight, preferably between about 0.1 and about 7% by weight, particularly preferably between about 0.5 and about 6% by weight, in particular between about 1 and about 5% by weight and most preferably between about 1.5 and about 4% by weight, for example, between about 2 and about 2.5% by weight, based on the total weight of the cleaning agent.

One or more dicarboxylic acids and/or salts thereof can be added to stabilize the agent as contemplated herein, in particular with high surfactant content, in particular a composition of Na salts of adipic, succinic and glutaric acid, for example, as is available under the trade name Sokalan® DSC. The use is advantageously carried out in amounts of from about 0.1 to about 8% by weight, preferably from about 0.5 to about 7% by weight, in particular from about 1.3 to about 6% by weight and particularly preferably from about 2 to about 4% by weight, based on the total weight of the cleaning agent.

However, if it is possible to dispense with their use, the agent as contemplated herein is preferably free from dicarboxylic acid (salts).

The washing agents as contemplated herein can be compared with reference washing agents to determine the increased washing performance of the agents as contemplated herein. Such a washing system can be composed as follows (all specifications in weight percent): Reference agent: from about 4-7% by weight LAS, from about 5-9% by weight anionic surfactants, from about 2-4% by weight C₁₂-C₁₈ fatty acid Na salts, from about 4-7% by weight nonionic surfactants, from about 0.1-1% by weight phosphonates, from about 1-4% by weight citric acid, from about 1-3% by weight NaOH, from about 1-3% by weight defoamer, from about 1-3% by weight glycerin, from about 0.05-1% by weight preservative, from about 0.5-2% by weight ethanol and remainder water (demin.). Agent as contemplated herein: from about 4-7% by weight LAS, from about 5-9% by weight anionic surfactants, from about 2-4% by weight C₁₂-C₁₈ fatty acid Na salts, from about 4-7% by weight nonionic surfactants, from about 0.1-1% by weight phosphonates, from about 1-4% by weight citric acid, from about 1-3% by weight NaOH, from about 1 to about 3% by weight defoamer, from about 1 to about 3% by weight glycerin, from about 0.05-1% by weight preservative, from about 0.5 to about 2% by weight ethanol, from about 0.001 to about 1% by weight amylase (SEQ ID NO:1) and remainder water (demin.). The dosage of the solid washing agent is preferably between about 45 and about 85 grams per wash solution, for example, about 50, about 65 or about 70 grams per wash solution. Preference is given to washing in a pH range between pH about 7.5 and pH about 9.5, preferably between pH about 8 and pH about 9.

The abovementioned embodiments of the present disclosure comprise all solid, powdery, liquid, gel-like or paste-like administration forms of agents as contemplated herein which, optionally, can also include several phases and can be present in compressed or uncompressed form. The agent can be present as a free-flowing powder, in particular having a bulk density of from about 300 g/l to about 1200 g/1, in particular from about 500 g/l to about 900 g/l or from about 600 g/l to about 850 g/l. The solid administration forms of the agent also include extrudates, granules, tablets or pouches. Alternatively, the agent can also be liquid, gelatinous or pasty, for example, in the form of a non-aqueous liquid washing agent or a non-aqueous paste or in the form of an aqueous liquid washing agent or a water-containing paste. Furthermore, the agent can be present as a one-component system. Such agents include one phase. Alternatively, an agent can also include a plurality of phases. Such an agent is therefore divided into a plurality of components.

A further subject as contemplated herein is a washing method comprising the method steps a) providing a washing or cleaning solution comprising an agent of this disclosure, and b) bringing a textile or a hard surface into contact with the washing or cleaning solution according to (a).

In various embodiments, the method described above is exemplified in that the agent as contemplated herein is used at a temperature of from about 0 to about 100° C., preferably 0 to about 80° C., more preferably from about 20 to about 55° C. and most preferably from about 25 to about 45° C.

These include both manual and mechanical methods, wherein mechanical methods are preferred. Methods for cleaning textiles are generally distinguished by the fact that various cleaning-active substances are applied to the items to be cleaned and washed off after the contact time in a plurality of method steps, or that the items to be cleaned are otherwise treated with a washing agent or a solution or dilution of this agent. All conceivable washing or cleaning methods can be added to in at least one of the method steps for the application of a washing or cleaning agent as contemplated herein and then represent embodiments of the present disclosure. All facts, subjects and embodiments described for agents as contemplated herein are also applicable to this subject as contemplated herein. Therefore, reference is expressly made at this point to the disclosure in the appropriate place with the statement that this disclosure also applies to the above method as contemplated herein.

A third subject as contemplated herein is the use of the agent as contemplated herein for the removal of starch-containing soilings.

All facts, subjects and embodiments described for agents as contemplated herein and the amylase are also applicable to the further subjects as contemplated herein. Therefore, reference is expressly made at this point to the disclosure in the appropriate place with the statement that this disclosure also applies to the above method as contemplated herein and the uses as contemplated herein.

### EXAMPLES

### Example 1: Stability Test

TABLE 1
Hand Dishwashing Matrix Used

| | % AM (raw | % active material |
|---|---|---|
| Trade or chemical name | material) | in the formula |
| LABS | 96 | 10-14 |
| Caustic soda | 50 | 2-5 |
| Galaxy SLES | 70 | 6-8 |
| Galaxy CAPB Plus | 37 | 1-4 |
| Parmetol A 28 S | 100 | 0-1 |
| Perfume 04-8862 | 100 | 0-1 |
| Tartrazine Yellow 85 E 102 | 1 | 0-1 |
| Potassium acetate | 70 | 0-1 |
| Ethanol | 100 | 1-4 |
| Water demin. | 100 | Radical |

TABLE 2
Washing Agent Matrix Used

| | % AM (raw | % active material |
|---|---|---|
| Trade or chemical name | material) | in the formula |
| Water demin. | 100 | Radical |
| Alkyl benzene sulfonic acid | 96 | 4-7 |
| Anionic surfactants | 70 | 5-9 |
| C12-C18 fatty acid sodium salt | 30 | 2-4 |
| Nonionic surfactants | 100 | 4-7 |
| Phosphonate | 40 | 0.1-1 |
| Citric acid | 100 | 1-4 |
| NaOH | 50 | 1-3 |
| Antifoam | t.q. | 0.01-1 |
| Glycerin | 100 | 1-3 |
| Preservative | 100 | 0.05-1 |
| Ethanol | 93 | 0.5-2 |

Without opt. Brightener, perfume, dye and enzymes;
Dosage: 4.7 g/L

### Activity Determination of the Amylase

The enzyme-containing solution is incubated under standardized conditions with soluble starch. The result is dextrins that contain terminal glucose residues with reducing groups. These form a stable, yellow color complex with p-hydroxybenzoic acid hydrazide (PAHBAH). The detection takes place in the flow at 410 nm.

The method is used to determine the amylase activity in raw materials and finished products with a continuous flow system in the concentration range of 30 to 450 CAE/liter.

### Storage Stability of the Amylase

To determine the storage stability of the amylase as contemplated herein, in each case 0.1% of the amylase as contemplated herein and 0.1% of the reference amylase were formulated in the matrices listed in Table 1 and 2.

Subsequently, the batches were stored at 30° C. and 40° C. in climatic chambers for 2, 4 and 8 weeks. After the appropriate periods of storage, a sample was taken and tested for residual amylase activity using the activity measurement described above.

### Results of Storage Experiments in Different Matrices

TABLE 3
Storage stability after storage in hand dishwashing matrix

| | | | | 0.1% amylase as |
|---|---|---|---|---|
| | | | 0.1% reference | contemplated herein |
| | | | amylase | (SEQ ID NO: 1) |
| Initial value | | | 100% | 100% |
| | 30° C. | 2 weeks | 74% | 73% |
| | | 4 weeks | 61% | 65% |
| | 40° C. | 2 weeks | 45% | 62% |
| | | 4 weeks | 26% | 56% |

TABLE 4
Storage stability after storage in washing agent matrix

| | | | | 0.1% amylase as |
|---|---|---|---|---|
| | | | 0.1% reference | contemplated herein |
| | | | amylase | (SEQ ID NO: 1) |
| Initial value | | | 100% | 100% |
| | 30° C. | 8 weeks | 83% | 89% |
| | 40° C. | 8 weeks | 51% | 79% |

As can be seen from the data in Tables 3 and 4, the amylase as contemplated herein has a markedly increased storage stability both in hand dishwashing washing agents and in washing agents. This improved storage stability could be determined both after storage at 30° C. and at 40° C.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. An agent comprising at least one amylase comprising an amino acid sequence having at least about 75% sequence identity over its entire length with the amino acid sequence given in SEQ ID NO:1.

2. The agent according to claim 1, wherein
the amylase is obtained from an amylase as a starting molecule by single or multiple conservative amino acid substitution.

3. The agent according to claim 1, wherein the agent, based on the total weight, comprises from about 0.0001 to about 1% by weight of amylase.

4. The agent according to claim 1, wherein the amylase comprises an amino acid sequence which is at least about 76%, identical to the amino acid sequence given in SEQ ID NO:1 over the entire length thereof.

5. The agent according to claim 1, wherein the agent further comprises at least one further component selected from the group of surfactants, enzymes, enzyme stabilizers, complexing agents for heavy metals, builders, bleaches, building agents, electrolytes, nonaqueous solvents, pH adjusters, odor absorbers, deodorizing substances, perfumes, perfume carriers, fluorescers, dyes, hydrotropes, foam inhibitors, silicone oils, anti-redeposition agents, grayness inhibitors, shrinkage inhibitors, further crease inhibitors, dye transfer inhibitors, antimicrobial active substances, germicides, fungicides, antioxidants, preservatives, corrosion inhibitors, anti-static agents, bittering agents, ironing auxiliaries, repellents and impregnating agents, swelling and anti-slip agents, softening components and UV absorbers.

6. The agent according to claim 5, wherein the agent comprises at least one surfactant selected from linear alkylbenzenesulfonates, alkyl ether sulfates, alkyl sulfonates, alkyl sulfates, monoglyceride sulfates, ester sulfonates (sulfofatty acid esters), lignin sulfonates, fatty acid cyanamides, anionic sulfosuccinic surfactants, fatty acid isethionates, acylaminoalkane sulfonates (fatty acid taurides), fatty acid sarcosinates, ether carboxylic acids, alkyl (ether) phosphates, alkylamido alkylamines, alkyl-substituted amino acids, acylated amino acids, betaines, fatty alcohol alkoxylates, alkyl phenol polyglycol ethers, end-capped polyglycol ethers, mixed ethers and hydroxy mixed ethers, fatty acid polyglycol esters, fatty acid alkanolamides, fatty acid polyglycol ethers, amine oxides, alkyl polyglucosides and combinations of the foregoing.

7. The agent according to claim 6, wherein the agent comprises at least one surfactant selected from linear alkylbenzenesulfonates, alkyl ether sulfates, betaines, fatty alcohol alkoxylates, amine oxides, alkylpolyglucosides and combinations of the aforementioned.

8. The agent according to claim 1, wherein the agent is a liquid textile washing agent or dishwashing washing agent.

9. (canceled)

10. A washing or cleaning method comprising the method steps
a) providing a washing or cleaning solution comprising an agent according to claim 1, and
b) bringing a textile or a hard surface into contact with the washing or cleaning solution according to step (a).

11. The agent of claim 1 wherein the amylase is obtainable as starting molecule by fragmentation, deletion, insertion or substitution mutagenesis and comprises an amino acid sequence that matches the starting molecule over a length of at least about 370 contiguous amino acids.

12. The agent of claim 1 wherein the amylase is obtainable as starting molecule by fragmentation, deletion, insertion or substitution mutagenesis and comprises an amino acid sequence that matches the starting molecule over a length of at least about 482 contiguous amino acids.

13. The agent of claim 1 that comprises about 0.006% to about 0.6% by weight of amylase.

14. The agent of claim 1 wherein the amylase comprises an amino acid sequence that is at least about 99.0% identical to the amino acid sequence given in SEQ ID NO:1 over the entire length thereof.

15. The agent of claim 1 wherein the amylase comprises an amino acid sequence that is 100% identical to the amino acid sequence given in SEQ ID NO:1 over the entire length thereof.

16. The agent of claim 1 wherein the amylase is obtainable as starting molecule by fragmentation, deletion, insertion or substitution mutagenesis and comprises an amino acid sequence that matches the starting molecule over a length of at least about 370 contiguous amino acids, wherein the agent comprises about 0.006% to about 0.6% by weight of amylase, and wherein the amylase comprises an amino acid sequence that is at least about 99.0% identical to the amino acid sequence given in SEQ ID NO:1 over the entire length thereof.

17. The agent of claim 1 wherein the amylase is obtainable as starting molecule by fragmentation, deletion, insertion or substitution mutagenesis and comprises an amino acid sequence that matches the starting molecule over a length of at least 482 contiguous amino acids, wherein the agent comprises about 0.006% to about 0.6% by weight of amylase, and wherein the amylase comprises an amino acid sequence that is 100% identical to the amino acid sequence given in SEQ ID NO:1 over the entire length thereof.
